(19) United States
(12) Patent Application Publication
(10) Pub. No.: US 2006/0101600 A1
(43) Pub. Date: May 18, 2006

(54) Mop head connector

(75) Inventor: Jace A. Weaver, Gilbertsville, PA (US)

Correspondence Address: Hollstein Keating Cattell Johnson & Goldstein P.C.;Willow Ridge Executive Office Park, Suite 301, 750 Route 73 South, Marlton, NJ, 08053, US

(73) Assignee: Quickie Manufacturing Corporation

(21) Appl. No.: 10/988,278

(22) Filed: Nov. 13, 2004

(51) Int. Cl. A47L 13/42; B25G 3/12

(52) U.S. Cl. 15/145; 16/422

(57) ABSTRACT

A connection system for securing a mop head to a mop handle. The system uses a handle connector component secured to the mop handle and a mop head connector component secured to the mop head. Through holes in the handle connector component are aligned with through holes in the mop head connector component. A resilient clip with protruding tabs is positioned in and around the mop head connector component, such that the tabs of the resilient clips extend through the aligned holes in the connector components. The resiliency of the clips compels the tabs into the holes, thus securing the components.

### BACKGROUND OF THE INVENTION

The cleaning section of a mop, normally referred to as the mop head, is routinely secured to the mop's handle by a threaded connection, i.e. threads at the end of the handle are screwed into a threaded opening in the mop head. In this manner, mop heads whose cleaning strands become old and ineffective can be discarded and new heads replaced on the mop handles.

However, this type of connection has several significant disadvantages. The threaded connection system between a handle and a mop head is prone to becoming loose during prolonged use of the mop. This requires constantly stopping the cleaning operation to tighten the handle/mop head connection. Also, repeatedly changing the mop head on the handle tends to cause the threads at the end of the handle to become worn and increasingly ineffective in securing the mop head.

### SUMMARY OF THE INVENTION

Accordingly, it the object of the present invention to overcome the limitations and disadvantages of prior mop head connections.

It is an object of the present invention to provide a mop head connection system which ensures for a quick and easy attachment between the mop head and handle.

It is another object of the present invention to provide a mop connection system for ensuring that there is always a secure connection between the mop head and the handle, especially during prolonged use of the mop.

It is another object of the present invention to provide a mop head connection system which is simple and economical to produce and which has a limited number of connection components.

It is a further object of the present invention to provide a mop head connection system with an attachment element which provides an easy and effective connection between the mop head and mop handle.

It is still another object of the present invention to provide a mop head connection system which uses a resilient clip to quickly and securely connect the mop head to the mop handle.

These and other objects are accomplished by the present invention, a mop head connection system which has a handle connector component secured to the mop handle and a mop head connector component secured to the mop head. Through holes in the handle connector component are aligned with through holes in the mop head connector component. A resilient clip with protruding tabs is positioned in and around the mop head connector component, such that the tabs of the resilient clips extend through the aligned holes in the connector components. The resiliency of the clips compels the tabs into the holes, thus securing the components.

The novel features which are considered as characteristic of the invention are set forth in particular in the appended claims. The invention itself, however, both as to its design, construction, and use, together with the additional features and advantages thereof, are best understood upon review of the following detailed description with reference to the accompanying drawings.

### BRIEF DESCRIPTION OF THE DRAWINGS

FIG. 1 is an isometric exploded view showing the alignment of the components of the mop head connection system of the present invention.

FIG. 2 is an isometric view of the clip component of the mop head connection system of the present invention.

FIG. 3 is an isometric view of the mop head connector component of the mop head connection system of the present invention.

FIG. 4 is an isometric view of the handle connector component of the mop head connection system of the present invention.

FIG. 5 is an isometric view of a mop head secured to a mop handle, using the mop head connection system of the present invention.

### DETAILED DESCRIPTION OF THE INVENTION

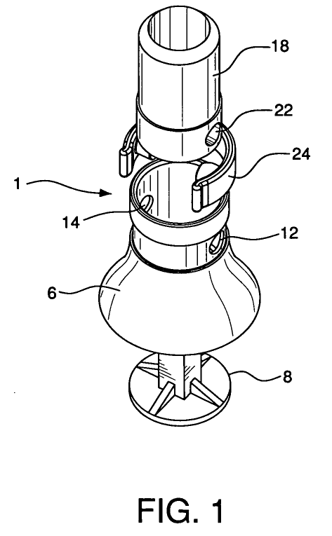

The mop head connection system 1 of the present invention is used on a mop comprising mop head 2 with cloth strands 4 which are secured in conventional fashion to mop head connector component 6 via mop strand connector 8. Mop head connector 6 has opening 10 at its upper end section 15 and through openings 12 and 14 parallelly aligned on either side of the upper end section of the mop head connector. Mop handle 20 is permanently connected by pressure fitting, tacks, or other known means, to one end of handle connector component 18. Handle connector 18 is substantially cylindrical in configuration and, at its lower end 19, comprises through openings 20 and 22 parallelly aligned on opposite sides of the connector. As seen in FIG. 1, handle connector 18 is configured to be inserted into mop head connector 6, such that through holes 20 and 22 of handle connector 18 and through holes 12 and 14 of mop head connector 6 are aligned with each other, forming an open pathway completely through the two overlaying connector components.

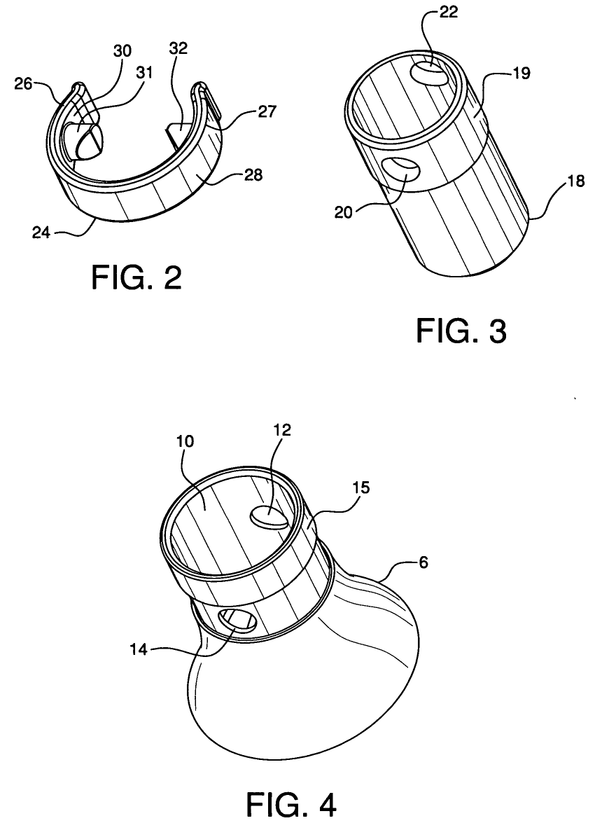

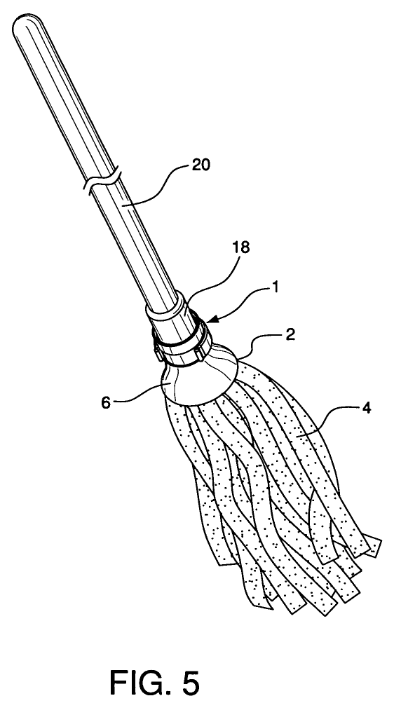

Clip 24 is curvilinear in configuration and comprises arms 26 and 27, outside surface 28, and inside surface 30. Extending from inside surface 30 are tabs 31 and 32, as shown in FIG. 2. Clip 24 is resilient, thus permitting arms 26 and 27 to be expanded outward and, upon release, to return to their original configuration.

After handle connector 18 is inserted into mop head connector 6, such that through openings 12, 14, 20, and 22 are aligned to form an opened pathway through both connector components, clip 24 is positioned over and around upper end section 15 of mop head connector 6. Arms 26 and 27 of clip 24 are spread apart and clip 24 is placed on mop head connector 6, with tabs 31 and 32 being inserted into through holes 12 and 14. The resiliency of clip 24 compels arms 26 and 27 of the clip to tighten around the upper end section 15 of mop head connector 6, forcing tabs 31 and 32 to snap into through openings 12, 14, 20, and 22. This joins mop head connector 6 and handle connector 18, resulting in a secure connection between mop head 2 and handle 20.

The secure connection provided by mop head connection system 1, by use of clip 24 resiliently maintaining mop head connection 6 and handle connector 18, ensures that the handle to mop head connection of the mop is maintained during use of the mop.

When it is desired to change mop head 2, after prolonged use of the mop head, arms 26 and 27 of resilient clip 24 can be spread apart, allowing the clip to be removed from through openings 12, 14, 20, and 22. This allows handle 20 with handle connector 18 to be withdrawn from mop head connector 6 and mop head 2. Handle connector 18 can then be inserted into opening 10 of new mop head connector 6, which is a component of a fresh, clean mop head 2. Through openings 12 and 14 of mop head connector 6 and through openings 20 and 22 of handle connector 18 are once again aligned, and resilient clip 24 reattached to the system. The mop is once again ready for use with a new, clean-mop head.

Certain novel features and components of this invention are disclosed in detail in order to make the invention clear in at least one form thereafter. However, it is to be clearly understood that the invention as disclosed is not necessarily limited to the exact form and details as disclosed since it is apparent that various modifications and changes may be made without departing from the spirit of the invention.

1. A mop head connection system for connecting a mop handle to a mop head, the system comprising:
(a) removeable fastening means for securely connecting the mop handle to the mop head;
(b) mop head connector means attached to the mop head for joining the mop head to the mop handle, said connector means comprising opening means into which the fastening means is inserted;
(c) handle connector means to assist in joining the mop head to the mop handle, said handle connector means comprising opening means aligned with the opening means of the mop head connector into which the fastening means is inserted, whereby insertion of the fastening means into both opening means securely attaches the mop head to the mop handle.

2. The mop head connection system as in claim 1 wherein the opening means of the mop head connector means comprises parallel aligned openings.

3. The mop head connection system as in claim 1 wherein the handle connector opening means comprises parallel aligned openings.

4. The mop head connection system as in claim 3 wherein the opening means of the handle connector means comprises parallel aligned openings.

5. The mop head connection system as in claim 1 wherein the fastening means comprises a resilient clip.

6. The mop head connection system as in claim 5 wherein the clip comprises resilient arm members and dual tabs for insertion into the opening means of the mop head connector means and the handle connector means.

7. The mop head connection system as in claim 1 wherein the handle connector means comprises a substantially cylindrical element insertable into the mop head connector means.

8. The mop head connection system as in claim 1 wherein the fastening means is removeable to allow the mop head to be disconnected from the handle.

9. A mop head connection system for connecting a mop handle to a mop head, the system comprising:
(a) a mop head connector attached to the mop head, said connector comprising parallel aligned openings;
(b) a handle connector attached to the mop handle, said handle connector comprising parallel aligned openings, said openings being aligned with the openings of the mop head connector; and
(c) fastening means for insertion into the mop head connector openings and the handle connector openings for securing the connectors and connecting the mop handle to the mop head.

10. The mop head connection system as in claim 9 wherein the fastening means is a resilient clip.

11. The mop head connection system as in claim 10 wherein the clip comprises resilient arm members and dual tabs for insertion into the openings of the mop head connector and handle connector.

12. The mop head connection system as in claim 8 wherein the handle connector is a substantially cylindrical element insertable into the mop head connector.

13. The mop head connection system as in claim 9 wherein the fastening means is removeable to allow the mop head to be disconnected from the mop handle.
